(19) United States
(12) Patent Application Publication
(10) Pub. No.: US 2014/0172183 A1
(43) Pub. Date: Jun. 19, 2014

(54) POWER APPARATUS

(71) Applicant: Ezra Sieferman Beeman, Maroubra (AU)

(72) Inventor: Ezra Sieferman Beeman, Maroubra (AU)

(73) Assignee: Empower Energy Pty Ltd, Maroubra, New South Wales (AU)

(21) Appl. No.: 14/235,038

(22) PCT Filed: Jul. 25, 2012
(86) PCT No.: PCT/AU2012/000882

§ 371 Date: Feb. 26, 2014

(30) Foreign Application Priority Data
Jul. 26, 2011 (AU) 2011902973

(51) Int. Cl. H02J 4/00; G06Q 50/06

(52) U.S. Cl. CPC H02J 4/00; G06Q 50/06
USPC 700/291; 307/23

(57) ABSTRACT

A power apparatus comprising an input connectable to a mains electrical supply; an energy storage device; a supply converter selectively connectable to an electrical supply to convert electrical power from the electrical supply to energy for storage in the energy storage device; a load converter arranged to convert energy from the energy storage device to electrical power for supply to an electrical load; an output, selectively connectable to either of the input or the load converter, by which the electrical load is coupled to the apparatus to receive electrical power; and a control device, coupled to a communications network, configured to: receive, from the communications network, time-dependent electrical pricing data associated with the mains electrical supply; determine a schedule using at least the received time-dependent electrical pricing data for each of (i) charging the energy storage device, (ii) supplying power from the input to the output, and (iii) discharging the energy storage device to the output, selectively connect the supply converter to the input according to the schedule; and selectively connect the output to either of the input or the load converter according to the schedule to provide electrical power to the electrical load.

### TECHNICAL FIELD

The present invention relates generally to energy storage and utilization and, in particular, to a power apparatus useful for efficient energy consumption.

### BACKGROUND

Electrical power supply is usually provided via a publicly accessible electricity power network grid arranged in a hierarchy of energy suppliers, energy retailers and energy consumers. Energy suppliers operate traditional power plants and supply the power generated by power plants to energy consumers via the electrical power network grid. The power plants may include coal fired power, wind farm, nuclear plant, geothermal, solar farm, hydroelectric plants, and gas turbines. In order to ensure stability and predictability of the electricity cost to the energy consumers, energy retailers purchase the power supplied by energy suppliers in bulk and on-sell the power to energy consumers.

Energy retailers are charged for their consumers' power usage according to a cost reflective network price. Cost reflective network pricing requires off-peak prices to be low to reflect the near zero marginal cost of distributing electrical energy during off-peak times, and peak prices to be high to reflect the Long Run Marginal Cost (LRMC) of expanding the energy network to distribute additional electricity.

The increased usage of renewable energy has impacted upon the power network. This increases the unpredictability of electricity demand from energy consumers, which impacts upon the electricity spot pricing (i.e., the real-time prices of electricity paid by energy retailers). The unpredictability of the electricity spot pricing further impacts the profitability of energy retailers. In Australia, the electricity spot price paid by retailers to suppliers can fluctuate between (minus)$2,000/MWh to (plus)$12,500/MWh, whilst consumers may typically pay between $0.12/kWh to $2.50/kWh.

### SUMMARY

According to a first aspect of the present disclosure, there is provided a power apparatus comprising: an input connectable to a mains electrical supply; an energy storage device; a supply converter selectively connectable to an electrical supply to convert electrical power from the electrical supply to energy for storage in the energy storage device; a load converter arranged to convert energy from the energy storage device to electrical power for supply to an electrical load; an output, selectively connectable to either of the input or the load converter, by which the electrical load is coupled to the apparatus to receive electrical power; and a control device, coupled to a communications network, configured to: receive, from the communications network, time-dependent electrical pricing data associated with the mains electrical supply; determine a schedule, using at least the received time-dependent electrical pricing data, for each of (i) charging the energy storage device, (ii) supplying electrical power from the input to the output, and (iii) discharging the energy storage device to the output; selectively connect the supply converter to the input according to the schedule; and selectively connect the output to either of the input or the load converter according to the schedule to provide electrical power to the electrical load.

According to another aspect of the present disclosure, there is provided a system comprising at least one power apparatus, a communications network, and a server computer device, said power apparatus comprising: an input connectable to a mains electrical supply; an energy storage device; a supply converter selectively connectable to an electrical supply to convert electrical power from the electrical supply to energy for storage in the energy storage device; a load converter arranged to convert energy from the energy storage device to electrical power for supply to an electrical load; an output, selectively connectable to either of the input or the load converter, by which the electrical load is coupled to the apparatus to receive electrical power; and a control device, coupled to the communications network, configured to receive a schedule from the server computer device by which the control device selectively connects the supply converter to the input and selectively connects the output to either of the input or the load converter according to the received schedule; and the server computer device is coupled to the communications network and is configured to: receive, from the communications network, time-dependent electrical pricing data associated with the mains electrical supply; determine the schedule for the power apparatus for each of (i) charging the energy storage device, (ii) supplying power from the input to the output, and (iii) discharging the energy storage device to the output, and send the determined schedule to the control device.

According to another aspect of the present disclosure, there is provided an application program, executable by a computerized processor for determining a schedule for an operation of a power apparatus, the power apparatus being configured to provide electrical power to an electrical load, the power apparatus comprising: an input connectable to a mains electrical supply; an energy storage device; a supply converter selectively connectable to an electrical supply to convert electrical power from the electrical supply to energy for storage in the energy storage device; a load converter arranged to convert energy from the energy storage device to electrical power for supply to an electrical load; an output, selectively connectable to either of the input or the load converter, by which the electrical load is coupled to the apparatus to receive electrical power; and a control apparatus configured for: selectively connecting the supply converter to the input according to the schedule, and selectively connecting the output to either of the input or the load converter according to the schedule to provide electrical power to the electrical load; and the application program comprising: code for receiving, from a communications network, time-dependent electrical pricing data associated with the mains electrical supply; code for determining a load forecast based on historical electrical consumption data of the electrical load or a standard profile of the type of electrical load; code for determining a schedule for discharging the energy storage device to the electrical load based on the determined load forecast, discharge cost of the energy storage device, and the received time-dependent electrical pricing data; and code for determining a schedule for charging the energy storage device based on the discharge schedule, a recharge profile of the energy storage device and the received time-dependent electrical pricing data.

### BRIEF DESCRIPTION OF THE DRAWINGS

At least one embodiment of the present invention will now be described with reference to the drawings, in which:

FIG. 1 shows a power apparatus upon which arrangements described can be practised;

FIG. 2 shows the controller of FIG. 1;

FIG. 3A shows how multiple power apparatus may be used in an electricity system;

FIG. 3B shows how multiple power apparatus may be controlled or aided in operation by a server in an electricity system;

FIG. 4 depicts a software architecture for the power apparatus;

FIG. 5 is a flow diagram of the interconnections of the various application programs of FIG. 4;

FIG. 6 is a flow diagram to develop a schedule and updating of the schedule of a power apparatus for a normal operational day;

FIG. 7 is a flow diagram for a method for determining a discharge schedule of the power apparatus;

FIG. 8 is an example of electricity forecast prices based on reliability pricing used in determining schedule of FIG. 7;

FIG. 9 is an example of electricity forecast prices based on network pricing used in determining schedule of FIG. 7;

FIG. 10 is an example of electricity forecast prices based on wholesale pricing used in determining schedule of FIG. 7;

FIG. 11 is an example of a load forecast used in determining discharge schedule of FIG. 7;

FIG. 12 is an example of a loss curve of a lead-acid battery;

FIG. 13 is an example of a discharge schedule and a forecast daily profit generated from the method of FIG. 7;

FIG. 14 is a flow diagram for a method for determining a schedule for charging of the power apparatus;

FIG. 15 is an example of battery charging stages;

FIG. 16 is an example of a charge schedule and a forecast energy charging cost from the method of FIG. 14; and

FIG. 17 is an example of a charging and discharging schedule.

### DETAILED DESCRIPTION

The present disclosure relates to a power apparatus operable to store and to supply power so as to minimise costs incurred for connected loads. The power apparatus minimises costs by storing electrical power into an energy storage device when the electricity price is relatively low and by supplying the stored electrical power to the electrical load when the electricity price is relatively high. The power apparatus manages the storing and supplying of electrical power based upon the relative costs of using stored and mains energy. Other factors such as forecasted wholesale electricity prices, weather, and any available network and retail supply tariffs may also be considered to optimise scheduling of storing of the electrical power to the power apparatus and supplying of the electrical power to a connected load by the power apparatus. The power apparatus may be transportable or in a fixed configuration at a premises.

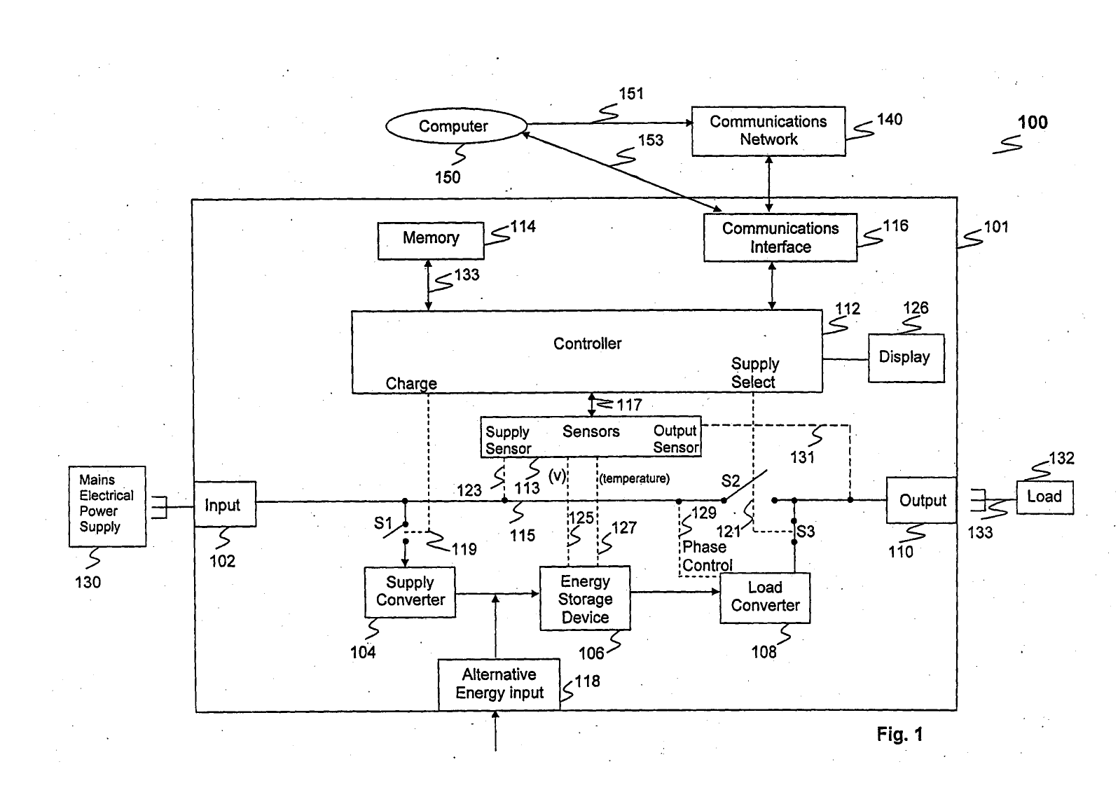

FIG. 1 shows a power apparatus (PA) 100 including an enclosure 101 having an input 102 for coupling to a mains electrical power supply 130, and an output 110 for providing electrical power to an electrical load 132. The PA 100 has a supply converter 104 for converting electrical power from the mains supply 130 to a form suitable for storage in an energy storage device 106. The PA 100 has a load converter 108 for converting the energy stored in the energy storage device 106 to electrical power for supply to the electrical load 132. The electrical load 132 may be an appliance such as a refrigerator, an oven, an air conditioner, a computer, an electric vehicle, a coffee machine or any other device that requires electricity for operation. The PA 100 may also include an alternative energy input 118 which may be generated from, inter alia, local solar panels, local wind turbines, local hydroelectricity, local generators, etc.

The output 110 is typically a power socket of the same configuration of the mains electrical power supply 130. An electrical load 132 can typically connect to the output 110 with a standard mains electrical supply complementary plug.

An arrangement of switches S1, S2, and S3, selectably switchable by a controller 112 of the PA 100, provide for the charging of the energy storage device 106 and the supply of electrical energy to the output 110 for powering the load 132. Switch S1 for example is closed when costs for the mains supply 130 are relatively low to thereby provide for storing energy in the energy storage device 106. Switches S2 and S3 are ganged for complementary operation to selectively couple the output 110 to one of the input 102, for supply from the mains supply 130, or to the load converter 108, for supply from the energy storage device 106. Typically S2 is closed and S3 is open when mains supply 130 costs are relatively low, and S2 is open and S3 is closed when the mains supply 130 costs are relatively high. Whilst FIG. 1 illustrates S2 and S3 as a complementary operating double-pole-double-throw switch, such may be implemented by a single-pole-double-throw switch.

The controller 112 controls selectable switches S1, S2, S3 via control signals transmitted via connections 119, 121.

In a typical and preferred implementation, the energy storage device 106 is a chemical battery (e.g., a lead acid battery, a lithium ion battery) and the converter 104 is a rectifier and a charger unit configured to rectify an AC mains supply 103 to DC for charging the battery 106. In an alternative embodiment, the converter 104 is configured to rectify AC power supply from the alternative energy input 118 to DC for charging the battery 106. In yet another alternative embodiment, the alternative energy input 118 may output DC power to directly charge the battery 106.

The load converter 108 is preferably an inverter configured to convert the battery voltage to a AC supply for the load 132, essentially mirroring the mains supply 130.

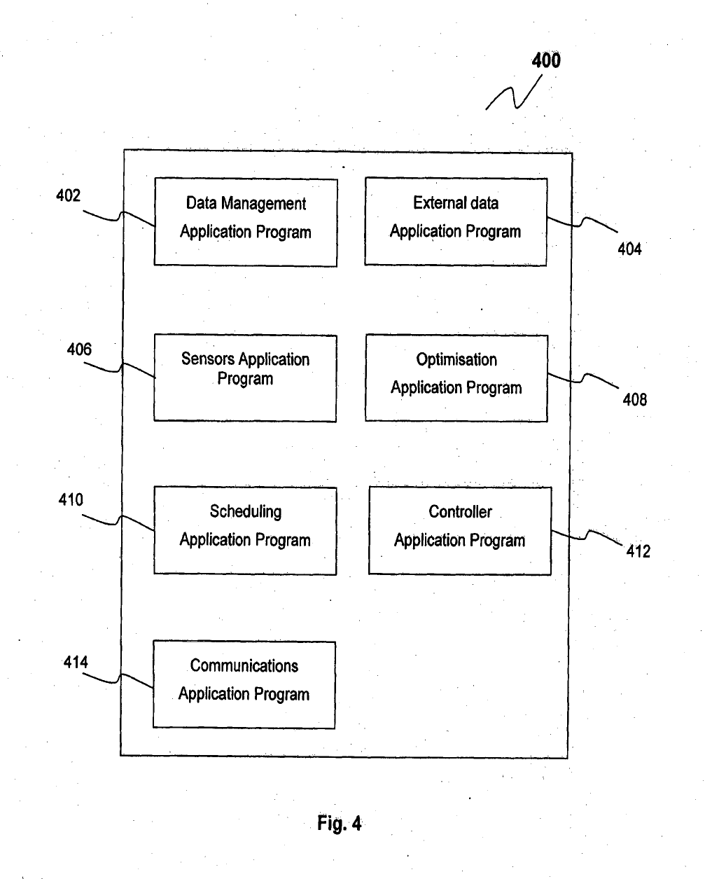

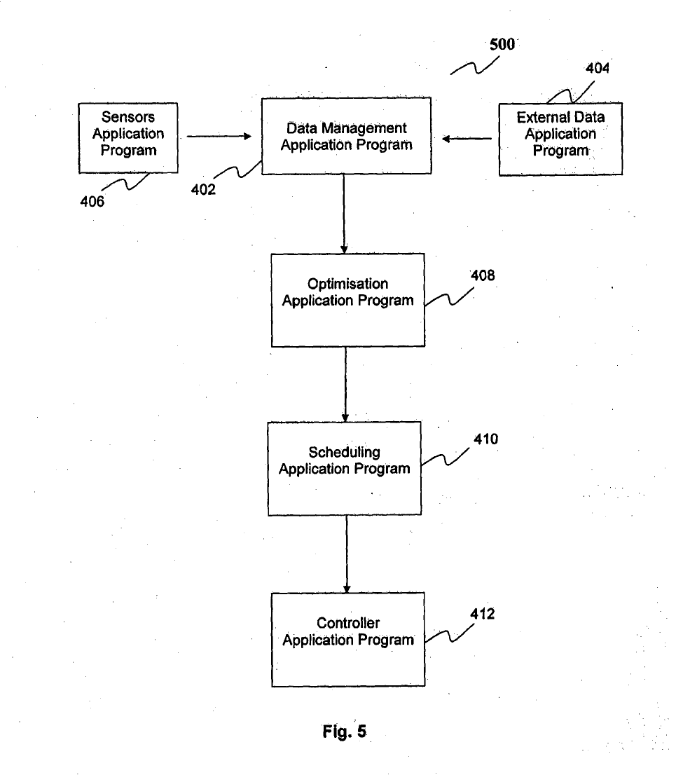

Sensors 113 are provided to measure supply voltage via connection 123, battery voltage via connection 125, battery temperature via connection 127, and load current via connection 131. A phase control connection 129 may be provided between the input 102 and the load converter 108 to ensure phase synchronisation between the two, as adjusted by operation of the load converter 108. Data from sensors 113 is transmitted to controller 112 via connection 117. The controller 112 processes the data from sensors 113 to execute a predetermined action based on the received data. The predetermined action is discussed in detail below in relation to FIGS. 4 and 5.

The controller 112 is associated with a memory 114, which stores a schedule of operation for the PA 100 to store and to supply electrical power, data from sensors 113 and any other application programs to operate the PA 100. Memory 114 is coupled to controller apparatus 112 via a connection 133. Controller 112 may also be connected to a communications interface 116, by which PA 100 is configured to communicate with a communications network 140. Communications network 140 may be a local area network (LAN), or a wide area network (WAN) such as the Internet. The communications network 140 may provide external data such as historical, current and forecasted electricity network prices, market prices, retailer/supplier prices, customer prices; forecasted electricity local demand; weather; and any other data that may impact the electricity price of the mains electrical power supply 130. The communications interface 116 may operate according to wired (telephone line) or wireless protocols.

The PA 100 is preferably configured as a transportable unitary device directly connectable between a traditional general purpose outlet (GPO), representing the mains supply 130, and the load 132, represented by an appliance as discussed above, having a lead and plug 133 that would ordinarily connect to the GPO. The PA 100 may be supplied for physical location with the load appliance 132 and the physical size of the PA 100 will depend predominantly by the energy storage capacity thereof. Such size will depend mainly upon the type of battery 106 used and the overall storage capacity. Although typically the PA 100 would not be regarded as “hand-portable” device, the enclosure 101 would typically be sized for relative ease of movement and positioning, by a trolley for example (e.g., have a volume between about 1.00 m³-1.50 m³).

FIG. 1 also shows a (local or remote) computer 150 connected via the communications network 140 and connection 151 to the communications interface 116, or alternatively directly to communications interface 116 via connection 153. The computer 150 is generally connected and operative during setup and installation to load application programs and default settings of PA 100 to memory 114 for execution by controller 112. Some examples of default settings of PA 100 include a reliability price of the load 132 coupled to a PA 100, battery type, battery size and tolerance threshold parameters of a PA 100.

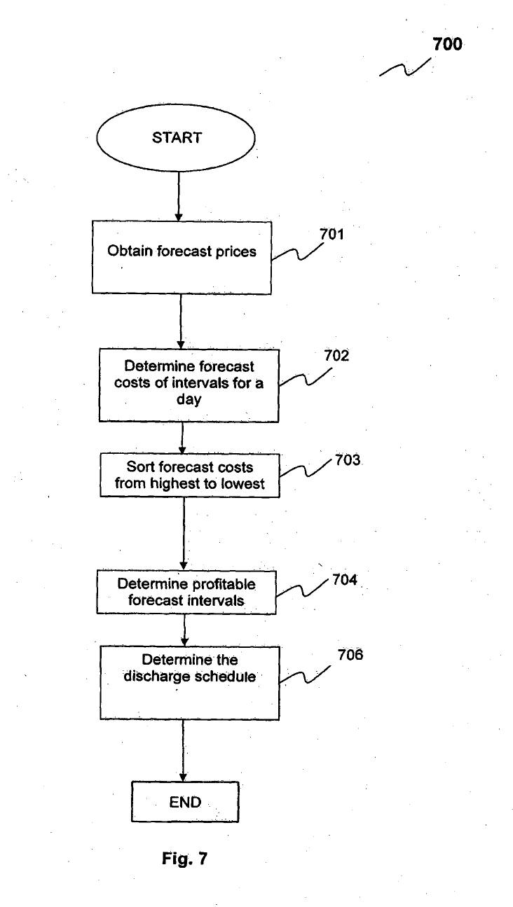

Reliability price of the load 132 is typically a user-specified price that sets the importance of maintaining power to the load 132 when mains electrical supply 130 is lost during a power outage. Higher reliability price equates to more importance in maintaining power to a load 132. Reliability price is further discussed in relation to FIG. 7.

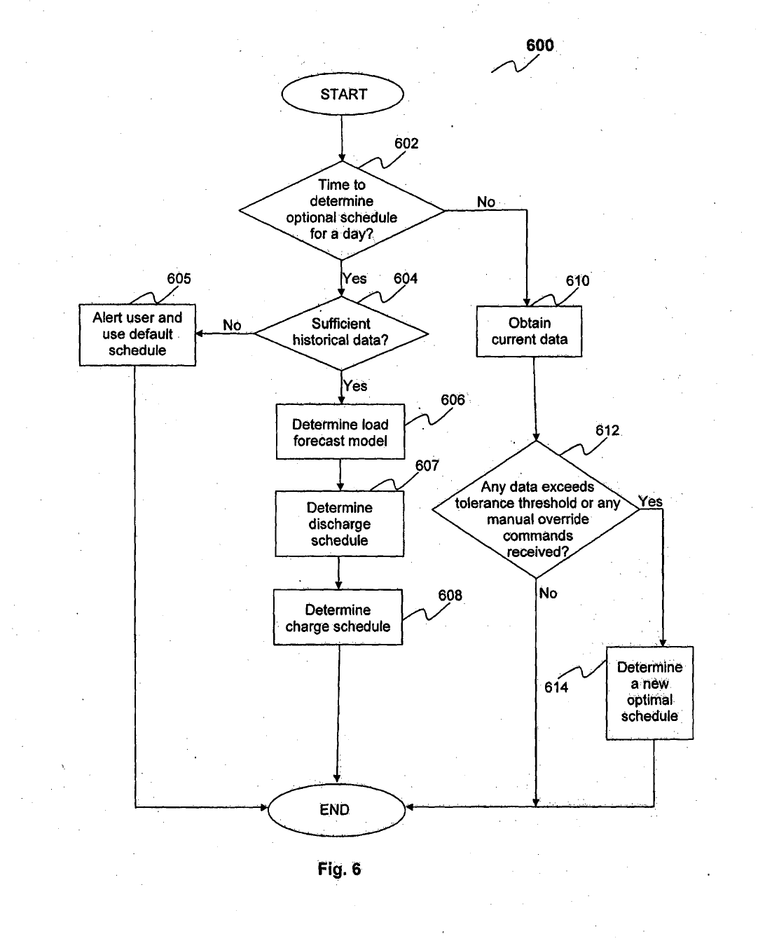

The tolerance threshold parameters are user-specified values that may establish actual electrical price difference against the forecasted electrical price; and nominal and maximum rates of charge, depths of discharge, and operating temperature of the battery 106. Tolerance threshold is further discussed in relation to FIG. 6.

Continued or operational connection permits the computer 150 to interact with PA 100 to display the status of PA 100 on the display (not shown) of computer 150. Further, sustained connection of the computer 150 allows a user to manually control the operation of PA 100 in exceptional circumstances. For example, a user may force PA 100 to shut down, to restart, to charge or discharge energy, to be bypassed or to execute a manually determined schedule. Typically, computer 150 only updates the default settings of PA 100 based upon new parameters entered by a user. In another implementation, computer 150 may also perform some of the functions of controller 112.

The controller apparatus 112 processes the received external data, in combination with data from sensors 113, to establish an optimal schedule for storing and supplying power by the transportable power apparatus 100.

The transportable power apparatus 100 may also include a display 126 coupled to the controller 112. The display 126 is typically a liquid crystal display (LCD) panel or the like that allows a user to check the status of the transportable power apparatus 100.

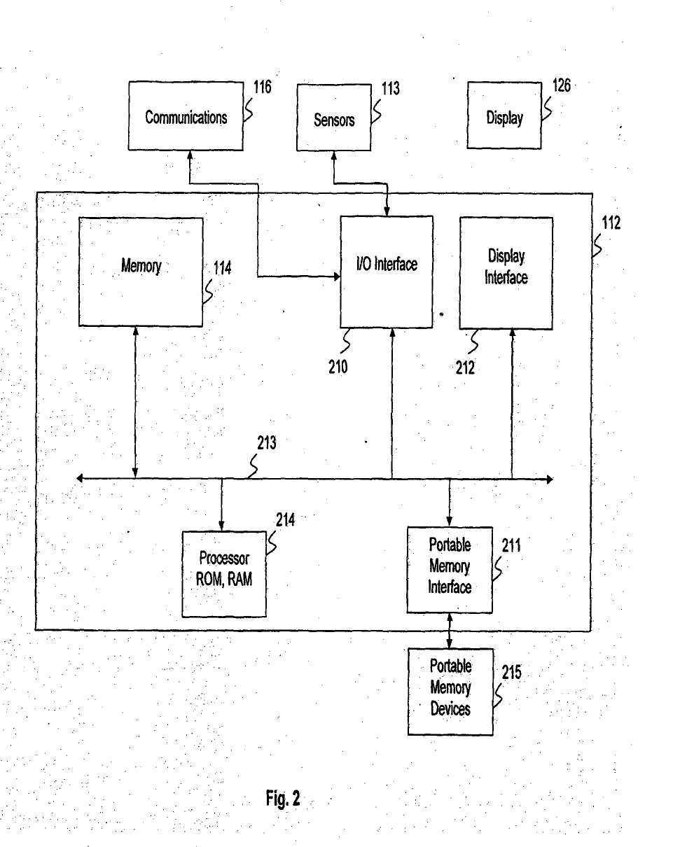

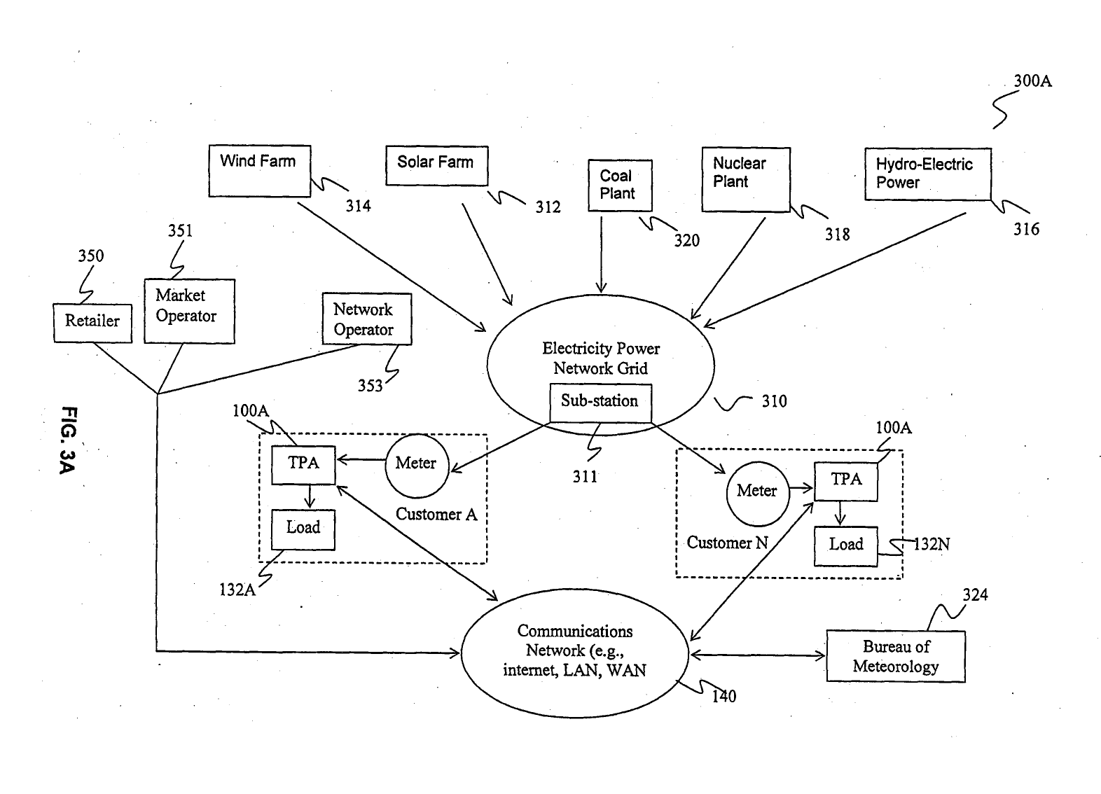

FIG. 2 shows a schematic block diagram of the controller 112 of the PA 100. The controller 112 comprises a processor 214 which is bi-directionally coupled via an interconnected bus 213 to a display interface 212, an I/O Interface 210, a portable memory interface 211, and the memory 114.

Typically the controller 112 has an on-board memory. Memory 114 is coupled to processor 214 as additional memory. The on-board memory of processor 214 and memory 114 may be formed from non-volatile semi-conductor read only memory (ROM), semi-conductor random access memory (RAM) and possibly a hard disk drive (HDD). The RAM may be volatile, non-volatile or a combination of volatile and non-volatile memory.

The sensors 113, discussed above, are also connected to the I/O Interface 210 for providing sensors data to processor 214.

FIG. 2 also shows that the controller 112 utilises I/O Interface 210 for coupling to the communications interface 116, for communicating with communications network 140.

The portable memory interface 211 allows a complementary portable memory device 215 to be coupled to the PA 100 to act as a source or destination of data. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks. These portable memory devices may be used to load the application programs and default settings of the PA 100.

The display interface 212 is connected to the display 126. The display interface 212 is configured for displaying information on the display 126 in accordance with instructions received from processor 214, to which the display interface 212 is connected.

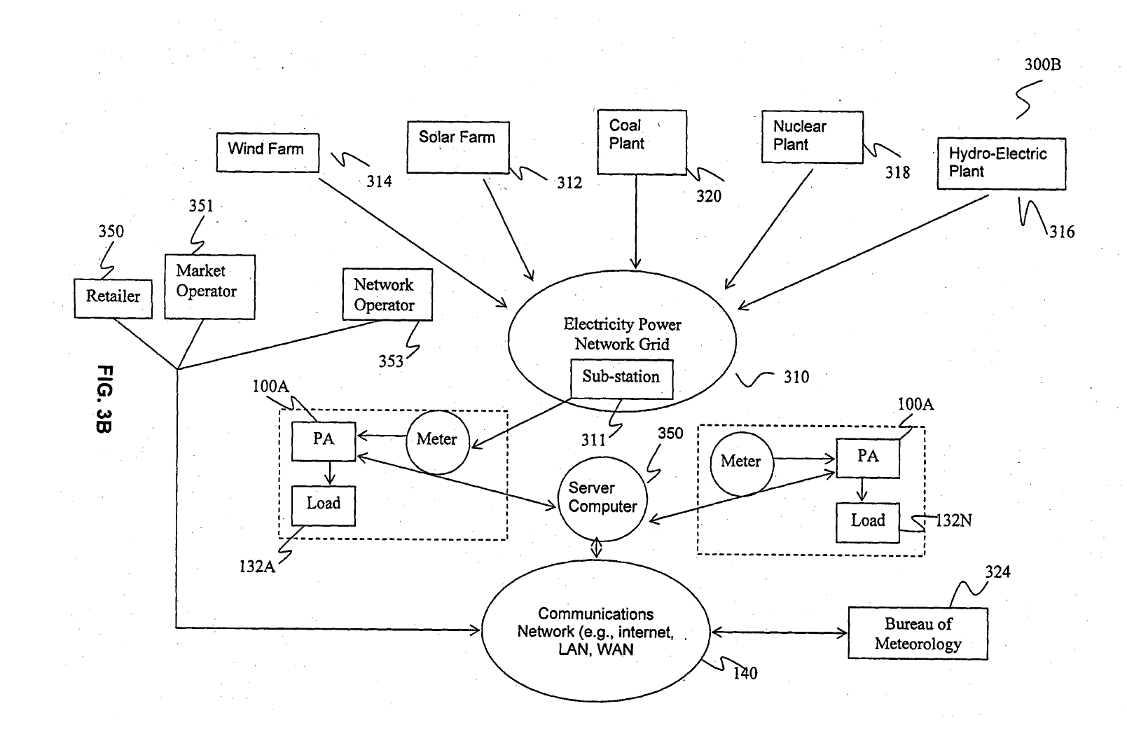

FIG. 3A shows a system including an electricity power grid 310 and the communication network 140 within which the power apparatus 100 may be connected. FIG. 3A depicts a decentralised system of multiple PAs 100. The electricity power network grid 310 is connected to electricity power generators such as coal plant 320, nuclear plant 318, hydroelectric plant 316, wind farm 314, and solar farm 312, or the like. The grid 310 also includes transformers (not shown), substations 311 and other structures which facilitate the supply and distribution of electrical energy from the power plants to the energy consumers. A retailer 350, a market operator 351, or a network operator 353 may be configured to provide a constant or periodic update on the network, retail, and wholesale electricity prices of the electricity power network grid 310 to the communications network 140. Network, retail, and wholesale prices are discussed below in relation to FIG. 7. System 300 also shows a plurality of PA 100a, . . . , 100n. The PA may be placed in businesses, houses or the like, each corresponding to electricity consumer having an electricity meter. The PA 100a, . . . , 100n are connected to the communication network 140 in order to obtain historical, current and forecasted electricity prices supplied by any of the retailer 350, the market operator 351, or the network operator 353. The communications network 140 may also be coupled to the Bureau of Meteorology 324 or other appropriate source to provide data on current and forecast weather. When the power apparatus 100 receives data from these sources, the controller 112 processes the received data and establish an optimal schedule for operation of the PA 100 for storing and supplying electrical power to the corresponding electrical load 132. In a specific implementation of the system of FIG. 3A, particularly where the PAs 100 are generally proximate and subject to the same supply availability and pricing, the PA 100a, . . . , 100n may also communicate with each other via the network 140 to determine optimal individual schedules for storing and supplying electrical power to corresponding electrical loads 132a, . . . , 132n.

For example, when a group of PA 100a, . . . , 100n in the same substation 311 communicate with each other and establish optimal individual schedules for that particular group, electricity demand for the particular substation may be decreased during peak hours when network price is high and increased during off-peak hours when network price is low, effectively saving money for the energy retailers and provide a better load distribution for the electricity power network grid 310.

FIG. 3B depicts a centralised system of PAs 100 used in an electricity system. A centralised server computer 350 is configured to operate a set of PA 100a, . . . , 100n. The server computer 350 collates the external data from a retailer 350, a market operator 351, or a network operator 353, and Bureau of Meteorology 324 and user-specified data, such as reliability prices, and establishes optimal schedules of PA 100a, . . . , 100n in order to minimise costs to connected loads 132a, . . . , 132n. The established schedules are then communicated to the respective PAs 100, which then implement the schedule by timely operation of the switches S1, S2 and S3.

The server computer 350 is typically a computer with a large processing power to monitor and to establish schedules for a group of PAs 100. Similar to the controller 112, the server computer 350 includes at least a memory, a processor, I/O interfaces, a display interface and a portable memory interface. The memory of the server computer 350 may include a database of PAs 100 that the server computer 350 is managing.

FIG. 4 is a representation of the software architecture 400 to operate the PA 100, and FIG. 5 is a flow diagram of a high level operation 500 depicting the interconnections between the application programs of the software architecture 400. The software architecture 400 comprises a data management application program 402, which manages system data and collated data from external data application program 404 and sensors application program 406. System data includes battery type, battery configuration, proprietary battery charge and discharge profiles, and battery manufacturer specification. External data application program 404 collates data from the communications network 140 and computer 150, whilst sensors application program 406 collects data from the sensors 113. The architecture 400 and applications programs 402-414 are stored in the memory 114 and are executable by the processor 214. The data provided by communications network 140, computer 150 and sensors 113 have been discussed above.

In a preferred implementation, as depicted in FIG. 5, the external data application program 404, sensors application program 406, and data management application program 402 collect and organise the data at predetermined intervals (e.g., every 24 hours) or at user-specified intervals (e.g., 5 minutes, 30 minutes, 60 minutes). The interval of collecting data may be amended by a user from computer 150.

The software architecture 400 has an optimisation application program 408, which processes the collated data of the data management application program 402 and produces optimal operating schedules for PA 100. The optimisation application program 408 also monitors for emergency situations and manual override commands from computer 150 for altering the schedule accordingly. Typically in a manual override situation, a user manually enters a new schedule and updates the PA 100 with the new schedule, which the optimisation application program 408 adopts.

For example, if selectable switch S2 is closed and the mains electrical power supply 130 loses power, the sensors application program 406 operates to detect the loss of power and the optimisation application program 408 subsequently processes the data and checks whether the reliability price of the load 132 is higher than the discharge cost of the battery 106. Discharge cost of a battery 106 is the potential cost incurred in discharging the battery to load 132. Discharge cost of the battery 106 is further discussed below in relation to FIG. 7. If the reliability price is higher than the discharge cost, it means it is cheaper for the user to discharge the battery 106 to load 132, than to allow load 132 to lose power. In this case, the optimisation application program 408 alters the schedule to allow the energy storage device 106 to supply electrical power to the electrical load 132 by effectively opening S2 and closing S3.

Typical operation of optimisation application program 408 in producing optimal schedules and updating of the optimal schedules is discussed below in relation to FIG. 6.

Scheduling application program 410 receives optimal schedules from the optimisation application program 408 and maintains the schedules for charging the energy storage device 106 and for selecting the electrical power supply for the output 110. The scheduling application program 410 includes an internal real-time clock to track the passage of time.

Controller application program 412 interprets schedules from scheduling application program 410 to selectively open and close switches S1, S2 and S3.

In a decentralised operation of PA 100 as depicted in FIG. 3A, communications application program 414 transmits the collated data of data management application program 402 and the optimal schedules produced by optimisation application program 408 to computer 150. Computer 150 subsequently displays the collated data and optimal schedules on a display of computer 150 for a user to monitor the operation of PA 100.

In a centralised operation of PA 100 as depicted in FIG. 3A, communications application program 414 receives optimal schedules set by optimisation application program 408 in computer 150 and transmits collated data from sensors application program 406 to computer 150. Computer 150 subsequently displays the sensors data on a display of computer 150 for a user to monitor the operating parameters of PA 100.

The methods described hereinafter is implemented using the processor 214, where the process of FIG. 6 may be implemented as one or more software application programs 402 to 414, shown in FIG. 4. In particular, with reference to FIG. 4, the steps of the described methods are effected by instructions in the software that are carried out within the processor 214. Alternatively, some of the described methods may be implemented in the server computer 350 if PAs 100 are operated in a centralised system. The software instructions may be formed as one or more code modules, each for performing one or more particular tasks. The code modules are stored in a memory and executable by either the PA 100 for a decentralised system or the server computer 350 for a centralised system.

Typically, the application programs 402 to 414 discussed above are resident on the memory 114 and are read and controlled in their execution by the processor 214, and in the following description, this will be assumed to be the case.

Intermediate storage of the application programs 402 to 414 and any data fetched from the communications network 140 may be accomplished using the on-board memory of processor 214, possibly in concert with the memory 114.

FIG. 6 is a flow diagram for a method 600 in determining an optimal schedule of charging and discharging of PA 100 for a normal operational day and updating of the optimal schedule upon receipt of new data and/or commands from communications network 140 and/or computer 150. The method 600 starts at step 602, which corresponds to the optimisation application program 408. Step 602 determines if an optimal schedule needs to be produced for the next day. Typically, the only time that an optimal schedule needs to be created for the next day is at the end of a current day. If an optimal schedule needs to be determined, step 602 moves to next step 604.

At step 604, the optimisation application program 408 determines whether sufficient historical data is available to forecast the electricity consumption of electrical load 132. Hereinafter, forecasts of electricity consumption of electrical load 132 will be referred to as the load forecast.

Typically, a 24 hour period of operating history of the same day type must have occurred before a load forecast can be determined. Day type includes weekday, weekend and holiday by default, but may also include additional day types relevant to a particular site. An example of relevant day types is school holidays for a business receiving custom from a nearby school.

For example, if the PA 100 is installed on a Thursday (i.e., a weekday), there is insufficient data to develop a load forecast for Friday (i.e., a weekday) as the PA 100 does not have a full 24 hour of a weekday data. There is also insufficient data to develop a load forecast for Saturday (i.e., weekend) as data collated on Friday is only for weekday. Thus, a first load forecast for weekend type is developed for the ensuing Sunday based on collected data on the Saturday. Accordingly, a first load forecast for weekday type is developed for the following Monday based on collected data on the Friday. If there is insufficient data, method 600 continues to step 605.

At step 605, the optimisation application program 408 sends a signal to communications application program 414 for notifying computer 150 that load forecast cannot be determined. In this case, the PA 100 runs a default schedule or a schedule that has been determined by a user.

On the other hand, method 600 advances to step 606 from step 604 if the optimisation application program 408 determines there is sufficient data. Load forecast is developed at step 606. The load forecast is determined from a best fit model for each interval i (e.g., 30 minutes or a shorter user-specified interval) using the equation:

kWhᵢ=α+β₁x₁+β₂x₂+β₃x₃+βₙxₙε (eqn. 1)

Where:
kWhᵢ=Forecasted Load at interval i

α=base electricity consumption (kWh)
X_{1 . . . n}=independent variables (e.g., weather (e.g., minimum and maximum temperature, humidity, precipitation, wind speed), type of day (e.g., weekday, weekend, holiday), type of week (e.g., Monday, Tuesday, etc), type of month (e.g., May, June, July, etc), type of season (e.g., summer, autumn, winter, spring), type of interval, etc)
β_{1 . . . n}=Estimated coefficient corresponding to each independent variable, which has been calculated using a standard linear regression method for minimising standard error term.
ε=Standard error term.

The base electricity consumption (α) is determined based on historical energy consumption data of a load 132 or a standard profile of the type of electrical load. For example, if the load 132 is a coffee machine, the base electricity consumption (α) may be the same coffee machine's historical data. Alternatively, the base electricity consumption (α) may be a standard profile of the electricity consumption of a comparable coffee machine or the electricity consumption of another electrical machine consuming electricity in a similar manner as a coffee machine.

The optimisation application program 408 tests each permutation of independent variables (i.e., X_{1 . . . n}) and selects the permutation with the best fit, as determined by the highest adjusted r-squared (i.e., a standard statistical measure for how well a regression line approximates real data points). Each independent variable coefficient (i.e., β_{1 . . . n}) is estimated for each permutation using historical data of the past one day, the past one week, the past one month and the past one year.

For example, initially the highest adjusted r-squared and associated coefficients (β_{1 . . . n}) are determined for a load forecast (forecast A) using all available independent variables (X_{1 . . . n}). Historical data of the independent variables (X_{1 . . . n}) are utilised to calculate the load forecast. Evaluation of eqn. 1 proceeds by removing one or more different independent variables (X_{1 . . . n}); calculating a new load forecast (forecast B) coefficients (β_{1 . . . n}); and determining the load forecast with the highest r-squared. The load forecast with the higher r-squared is kept. The permutations continue until all permutations have been tested, and the permutation with the highest r-squared is determined.

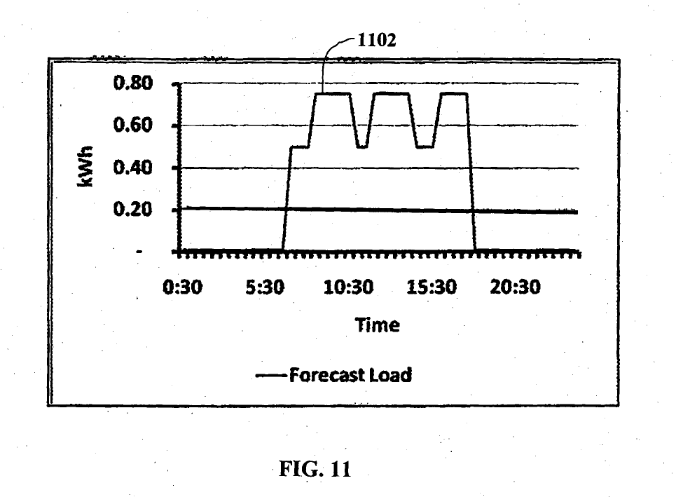

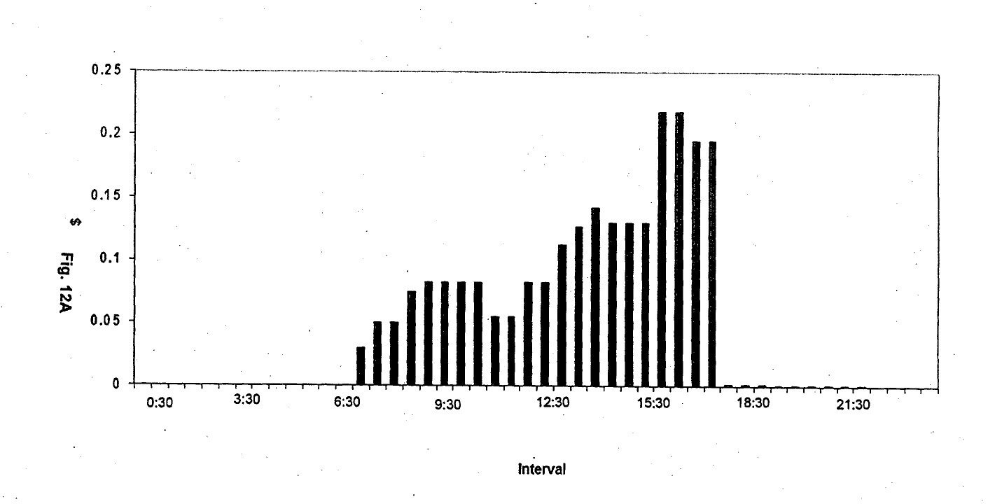

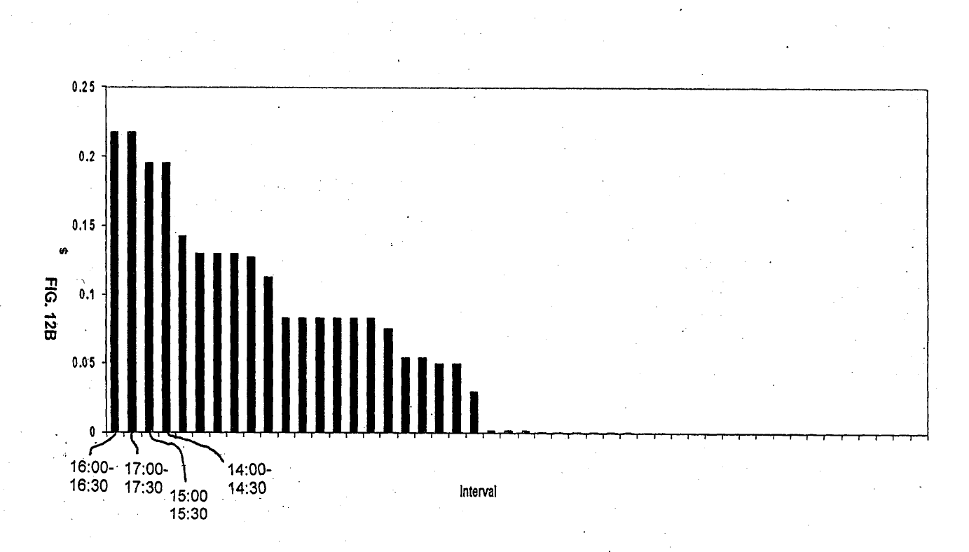

An example of a load forecast for a day is shown in FIG. 11. Method 600 advances to step 607.

Step 607 develops a discharge schedule for a day for the PA 100. The discharge schedule is developed based upon minimising the cost of supplying the connected load 132. Development of discharge schedule is discussed in relation to FIG. 7.

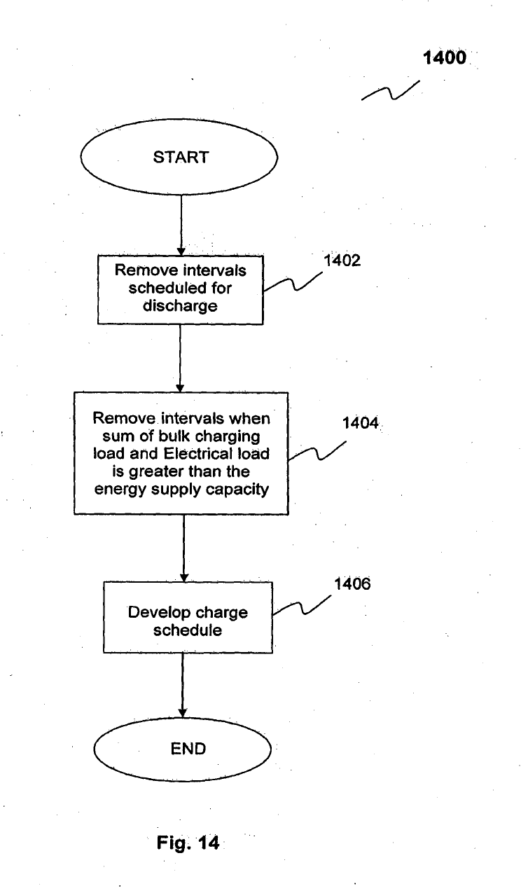

Method 600 advances to step 608. At step 608, the optimisation application program 408 develops a charge schedule for PA 100. Details for developing a charge schedule is discussed in detail in relation to FIG. 14. The method 600 concludes when step 608 is complete.

If at step 602 the optimisation application program 408 determines that a new schedule does not need to be generated, the method 600 advances to step 610. At step 610, the optimisation application program 408 obtains current data from communications network 140, computer 150 and sensors 113. The method 600 continues to step 612.

At step 612, the optimisation application program 408 determines if any current data exceeds a forecast price, a forecast cost or any other electrical parameters (e.g., battery depth of discharge, battery temperature) by a tolerance threshold value set by a user. Forecast price and forecast cost are discussed in relation with FIG. 7.

For example, a user may set a tolerance threshold for battery depth of discharge to +1% for a battery specified as having a nominal depth of discharge of 50%. If the battery depth of discharge has exceeded the allowable threshold (i.e., above 51%), the optimisation application program 408 may alter the schedule to effectively disconnect the battery from mains supply 130 and load 132. A battery depth of discharge is set to prevent the battery from being discharged beyond 50% because a depth of discharge beyond 50% may significantly increase the discharge cost possibly exponentially.

Typically, such a battery that is regularly discharged to 50% of its full capacity will last about 6 years. Conversely, the same battery that is regularly discharged to 90% or above will last only about 3 years.

Typically, the optimisation application program 408 monitors whether data has exceeded a tolerance threshold in real time. If no data has exceeded the corresponding tolerance threshold, the method 600 concludes. Otherwise, method 600 advances to step 614.

Step 614 performs the procedure described in steps 606 to 608, and generates a new schedule for the charging and supplying of electrical power by PA 100. Method 600 concludes after generating a new optimal schedule.

FIG. 7 is a flow diagram for a method for determining a discharging schedule of the PA 100. The method 700 commences with step 701, which determines at least four different forecast prices for each user-specified interval for one full day.

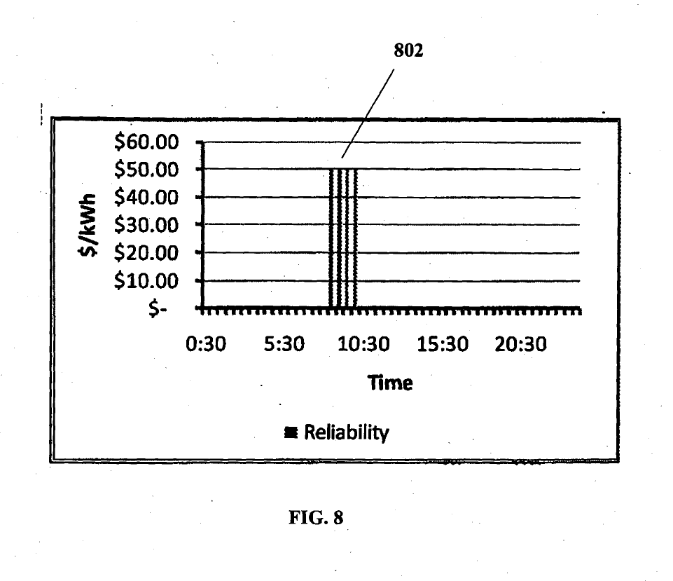

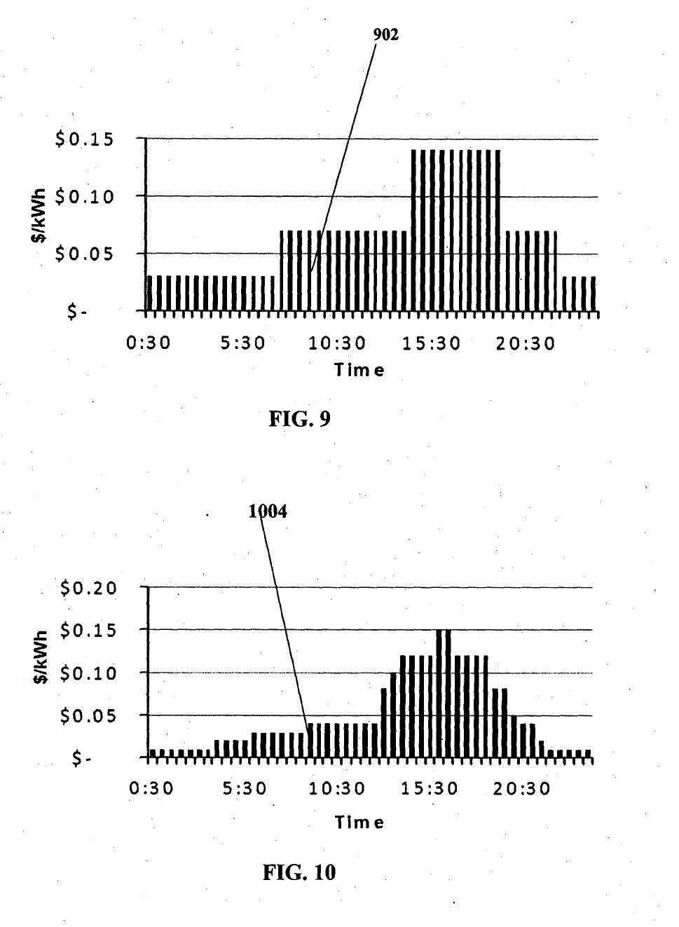

The four forecast prices are as follows:
Reliability forecast price is typically based on a local consumer-specified value of maintaining power to an electrical load 132. This value may be amended by an authorised local consumer at any time. An example is shown in FIG. 8.
Network forecast price based on a smart meter tariff set by network operator. The price may be based on a Time-of-Use structure. Typically, the price is fixed on an annual basis, but the price may also be dynamic. An example is shown in FIG. 9.
Wholesale forecast price based on an electricity forecast price of wholesale market energy for the interval. Wholesale prices are established on a real-time basis. An example is illustrated in FIG. 10. FIG. 10 depicts the network forecast price 1002 and the wholesale forecast price 1004. A line has been drawn to differentiate between the network forecast price 1002 and the wholesale price 1004.
Retail forecast price based on a smart meter tariff set by network operator. The price may be based on a Time-of-Use structure. Typically, the price is fixed on an annual basis, but the price may also be dynamic.

An example of fixed retail pricing may be for time-of-use consumer charges, such as:

| | | |
|---|---|---|
| Peak: | $0.36/kWh | (Monday-Friday 2 pm-8 pm) |
| Shoulder: | $0.13/kWh | (7 am-2 pm, 8 pm-10 pm Monday-Friday, and |
| | | 7 am-10 pm Saturday-Sunday.) |
| Off-Peak: | $0.08/kWh | (10 pm-7 am every day) |

A related pricing approach may also apply at the network level.

Dynamic pricing may be, for example in a retail situation, twelve (12) instances per annum of a rate of $2.50/kWh for any 2 hour period, with notification of that period being advised no less than 30 minutes before the commencement of the dynamic price period.

Upon completion of step 701, method 700 advances to step 702.

At step 702, forecast costs for one full day of intervals are determined. The equation used to determine the forecast cost for an interval is:

FCi=(Reliability forecast priceᵢ+Network forecast priceᵢ+Wholesale forecast priceᵢ+Retail forecast priceᵢ)×Interval×kWhᵢ (eqn. 2)

FCi=forecast cost for interval i;

Interval=length of interval i in hour unit: and

kWhᵢ=Forecasted load at interval i (discussed hereinbefore).

Typically, two FCi values for two events, relating to a normal operation and a power outage, are determined. The first FCi for a normal operation (hereinafter referred to only as FCi) does not include the reliability forecast priceᵢ, whilst the second FCi for a power outage event (hereinafter referred to as FCi outage) includes the reliability forecast priceᵢ. Typically, a schedule for a normal operation and a schedule for a power outage are determined using the FCi normal and the FCi outage, respectively. Alternatively, the FCi outage and the corresponding schedule for a power outage event may be determined when a power outage actually occurs.

For example, the load forecast (kWhᵢ) between 9 am and 10 am, as shown in FIG. 11 with reference numeral 1102, is 0.75 kWh. The forecast prices for the corresponding interval are $50/kWh (802), $0.08/kWh (902), and $0.11/kWh (1004). The combined forecast prices for the interval is $50.19/kWh. Thus, by using eqn. 2, the forecast cost (FCi outage) for the interval between 9 am and 10 am is $37.6425, which is obtained by multiplying $50.19 (the aggregate of forecast prices) with 1 hour (the interval of 9 am to 10 am) and with 0.75 kWh (kWhᵢ). On the other hand, the combined forecast prices for FCi normal is $0.19/kWh and the FCi normal is $0.1425.

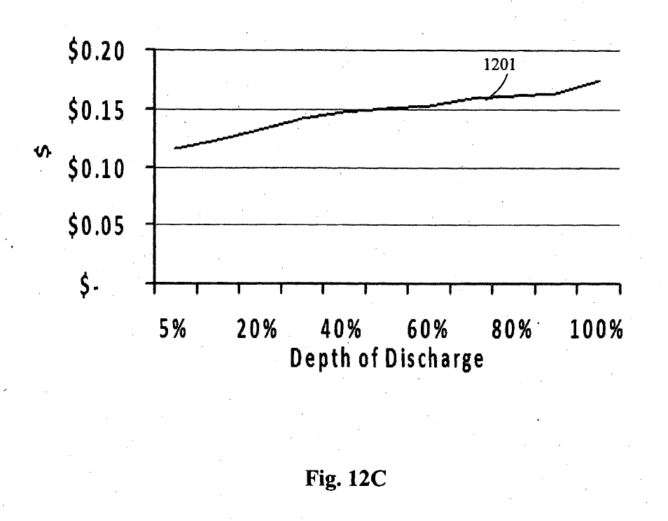

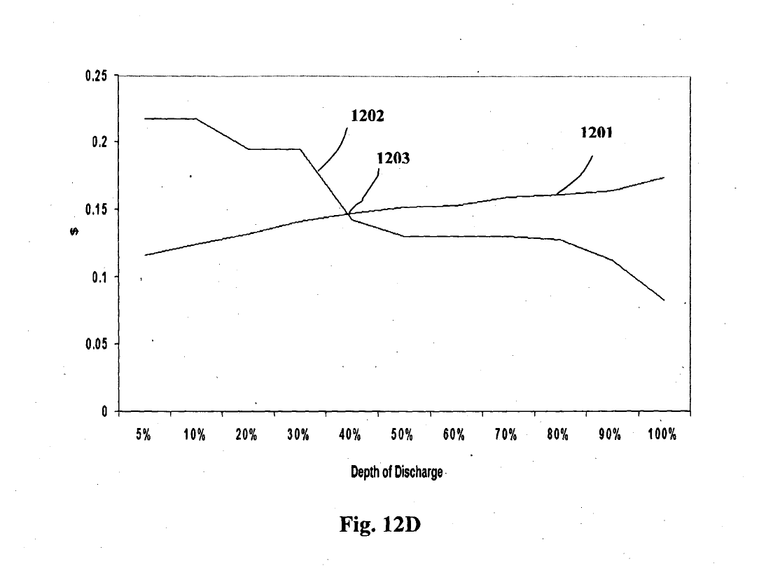

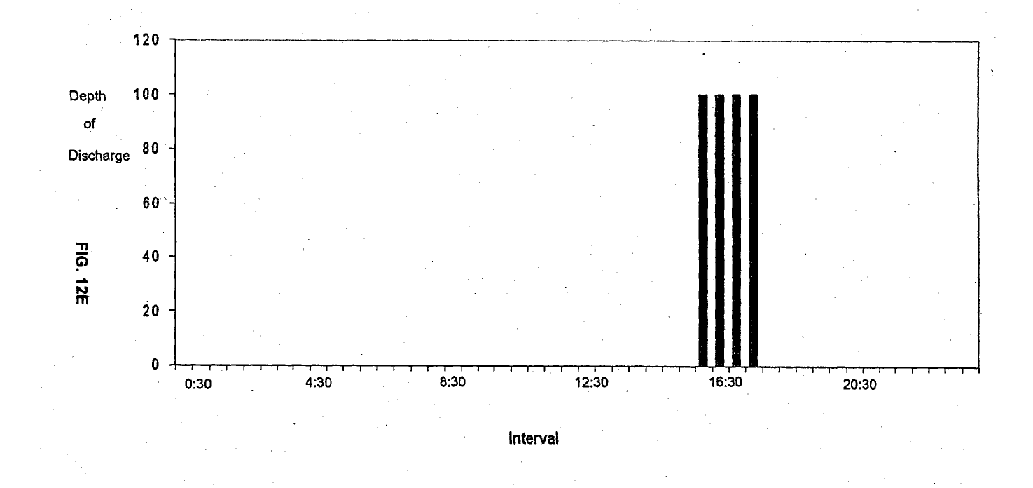

FIG. 12A illustrates an example of the forecasted cost (FCi) for one full day of intervals based on the load forecast, shown in FIG. 11, and the aggregates of forecast prices. Each interval is a 30 minute period.

Method 700 advances to step 703 when the forecast costs of intervals in a day are calculated.

Step 703 sorts the forecasted costs (FCi) from highest to lowest. FIG. 12B shows an example of the result of the sorting of step 703. Method 700 advances to step 704

Step 704 determines the most profitable intervals when the forecast cost is greater than the battery discharge cost. The discharge cost is the cost of discharging the energy storage device 106 of PA 100.

FIG. 12C shows an example of a discharge cost curve 1201 of a typical lead-acid battery that may be use for, or as part of, the energy storage 106. The discharge cost is based on tests carried out on an energy storage device by the energy storage device manufacturer and after proprietary services. The tests determine the impact of various depths of discharge, rates of charge and discharge, temperature of a battery on the battery energy capacity, the losses from battery storage and battery lifetime.

For example, the discharge cost for a one hour interval of discharge at 75% depth of discharge is approximately $0.16/kWh multiplied by one hour which equates to $0.16. In another example, for a two hour interval of discharge at 100% depth of discharge is approximately $0.175/kWh multiplied by 2 hours which equates to $0.35. These examples do not take into account the reduction of available energy and capacity (kW) as the battery is being discharged. Thus, when determining the discharge schedule, the method 700 minimises the load supply cost by ensuring that the battery 106 is not discharged uneconomically.

An example of selecting the most profitable intervals is now demonstrated. The sorted forecast cost (FCi) is compared with the battery discharge cost by comparing the parameters, as diagrammatically shown in FIG. 12D. FIG. 12D is the merging of FIGS. 12B and 12C. Note that only the top ten intervals in regard of the forecast cost (FCi) have been shown as the battery 106 is at 100% depth of discharge if the battery 106 is discharged for all ten intervals.

FIG. 12D represents battery discharge cost 1201 and forecast cost 1202. The left side of FIG. 12D automatically presents the profitable intervals, whereby the forecast cost 1202 is above the discharge cost 1201. Typically, the intersection between the forecast cost 1202 and the discharge cost 1201 signifies the end of the profitable intervals. Thus, FIG. 12D shows that the battery 106 is to be discharged only for the first four intervals, which correspond to the intervals of 16:00, 16:30, 17:00, and 17:30 of FIG. 12B.

The net effect of the above is that the determination of operating schedule of the PA 100 includes consideration of the discharge cost of the energy storage device 106, consumer cost, retail price, network price, electricity market price, and electricity supply cost. That consideration can therefore contribute to optimising the economic lifetime of the battery 106, for example by avoiding (i) uneconomical excessive discharge, (ii) uneconomical rates of discharge, and (iii) uneconomical heating or cooling

Method 700 advances to step 706 upon completion of step 704.

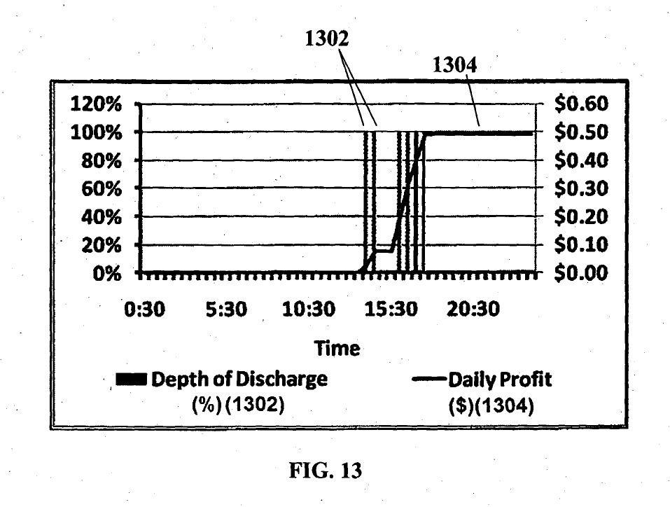

At step 706, a discharge schedule is developed based on the selected intervals of step 704. FIG. 12E shows the discharge schedule of the corresponding day of FIG. 12D. FIG. 13 shows another example of a discharge schedule of forecast intervals maximising profit illustrating forecast discharge intervals 1302, maximum depths of discharge of energy storage device 106, and forecast profit 1304 based upon the discharge schedule. The depth of discharge depicted in FIGS. 12E and 13 is the maximum depth of discharge allowed for the intervals which has been determined to maximise profit. Method 700 concludes upon completion of discharge schedule.

FIG. 14 is a flow diagram of a method for developing a charge schedule for PA 100. Method 1400 starts at step 1402 by removing intervals that has been assigned by method 700 to be discharge intervals. Method 1400 advances to step 1404.

At step 1404, the optimisation application program 408 removes intervals when the sum of charging load and forecast load would exceed the load capacity of the mains supply 130. For example, the mains supply 130 may be limited to 240 VAC 15 A for a GPO in Australia. If the forecast load for the interval is 10 A and the bulk charging load is 10 A, then the sum of the forecast load and the bulk charging load is 20 A, which exceeds the capacity of mains supply 130 of 15 A. The interval is consequently removed from the charging schedule. Charging load levels is discussed below. Method 1400 progresses to step 1406.

At step 1406, a charge schedule for one day is developed based on forecast cost (FCi), and battery recharge profiles and corresponding discharge costs.

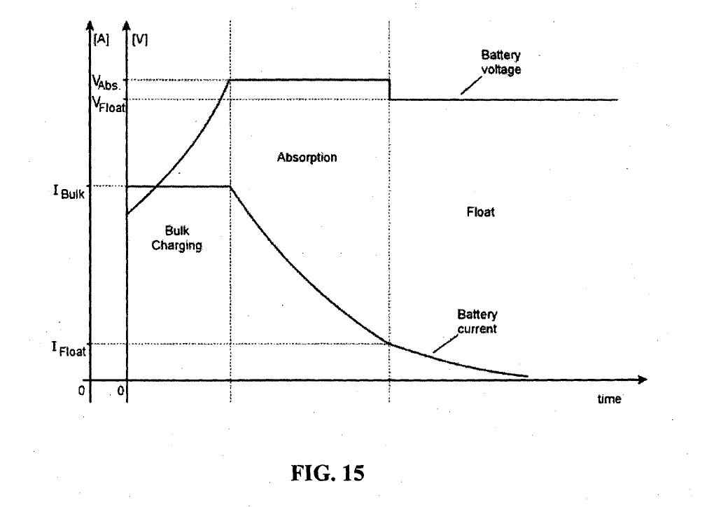

FIG. 15 is a diagram showing an example of a lead-acid battery charging process. The charging process of a lead-acid battery involves three stages: bulk charging, absorption and float. At bulk charging, a current from mains supply 130 is applied to the battery. Typically a charger forming part of the supply converter 104 controls the amount of voltage and current applied to the battery 106. At bulk charge stage, the charger holds the charge current steady. Different charge current results in different charging rate, which affects the battery energy capacity, battery life, and battery discharge cost. Typically, the charger delivers most of the charge current at maximum rate.

When a battery 106 reaches maximum allowable voltage, the battery 106 has reached the absorption stage and the charger changes to holding the charge voltage at a constant level. The constant charge voltage allows the battery 106 to “absorb” the current. Consequently, the charging current declines. Typically, the absorption step continues until current through the battery declines to about 2% of battery capacity whereupon a float or trickle charge condition is maintained at the nominal battery voltage. For example, a 100 Ah battery would have 2 Amps of absorption current flowing through the battery.

At the float step, a lower charge current is applied to the battery for maintaining a full charge state.

Forecast costs (FCi) are used for determining relatively low cost intervals. Depending upon the charge current, bulk charging of the energy storage device 106 may take only one interval or several intervals, and will affect the charge schedule.

A recharge profile is determined by the battery manufacturer and/or proprietary battery testing by a third party based on actual testing carried out determining the impact of various rates of charge on battery energy capacity, battery losses and battery lifetime cost. A recharge profile also has a corresponding charge cost. For example, when a battery 106 is bulk charged at an excessively high current, the battery 106 charges faster but consequently incurs more damage to the battery 106, which results in a higher charge cost and shortening of the lifetime of battery 106.

For example, forecast costs for 30 minute intervals between a period of 8 am to 10 am are $0.25, $0.15, $0.20, and $0.30. A first recharge profile with low charge cost may require two 30 minute intervals but a second recharge profile with medium charge cost may require three 30 minute intervals. The optimisation application program 408 analyses the first and second recharge profiles using different combination of intervals to determine a set of charge intervals with the lowest cost. Thus, the optimisation application program 408 effectively optimises the charging current of the battery 106 to determine the minimal battery charging costs.

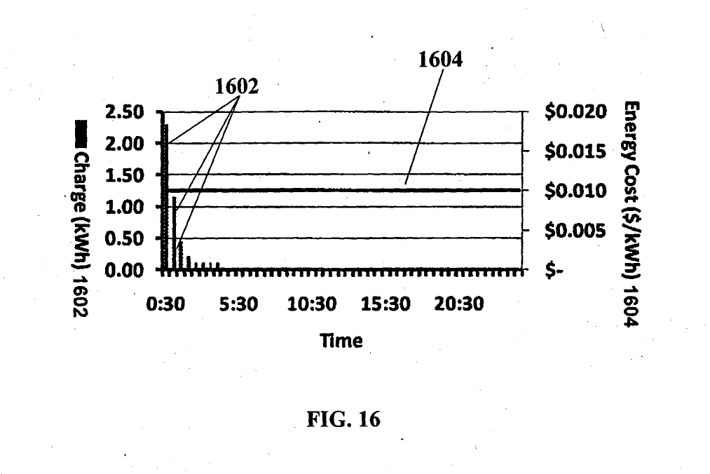

FIG. 16 is an example of a charge schedule and average cost of charging the energy storage device 106. As shown in FIG. 16, the intervals 1602 between midnight and 7 am are used to charge the battery 106, and there are different rates of charge as the battery 106 goes through different charging stages. The associated energy cost 1604 for charging the battery 106 is also shown.

Upon determining the optimal charge schedule, the optimisation application program 408 updates the discharge cost to be used by method 700.

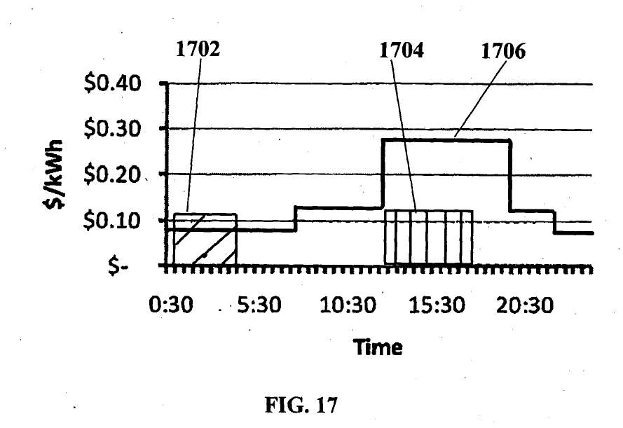

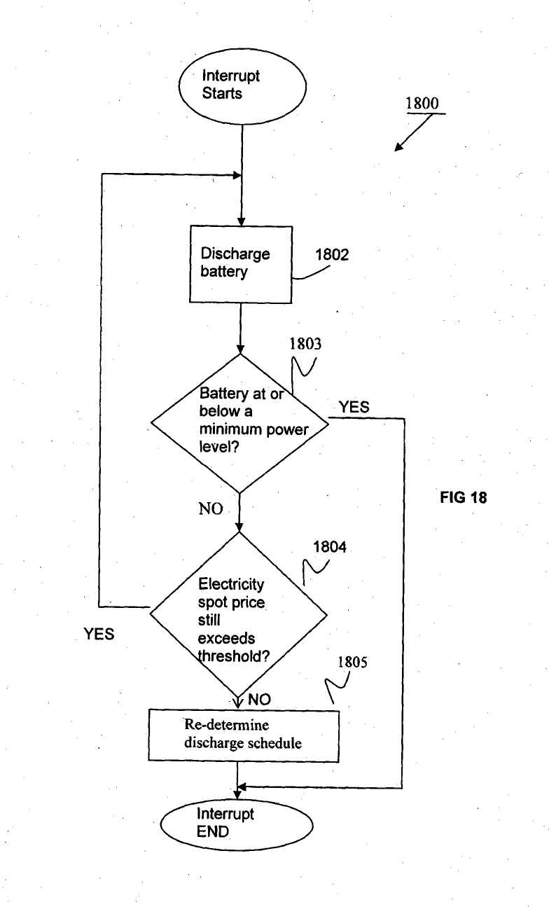

FIG. 17 depicts an example of a schedule for charge intervals 1702 and discharge intervals 1704 with the associated network price 1706 shown. The figure depicts an example whereby the charge intervals 1702 were performed when the network price is relatively low and discharge intervals 1704 were performed when the network price is relatively high.

Method 1400 concludes upon determining a charge schedule for PA 100.

FIGS. 18A and 18B collectively show an alternative method 1800 in determining an optimal schedule of the PA 100. In this alternative method, the PA 100 conserves the battery 106 for discharge at a period of electrical price spike or at the end of the day when no such spike occurs that day.

The method 1800 comprises a discharge/charge scheduling method 1800A and an interrupt method 1800B. During normal operation, the method 1800 loops in the discharge/charge scheduling method 1800A. However, when there is a spike in the electricity spot price, the interrupt method 1800B interrupts the operation of the method 1800A to go to the interrupt method 1800B.

The discharge/charge schedule method 1800A commences at step 1806, which determines whether the current time is a scheduled discharge time. The scheduled discharge time is determined by a user or by the Optimization Application Program 408 according to the forecasted electricity prices as described hereinbefore. If the current time is a scheduled discharge time (YES), the method 1800A proceeds to step 1808. Otherwise (NO), the method 1800A continues to step 1812.

At step 1808, the method 1800A determines whether the battery 106 exceeds an energy storage device threshold. The energy storage device threshold may be determined by a user setting. The energy storage device threshold is a minimum energy storage power level required for discharge when an electrical price spike (i.e., electrical spot price exceeding the threshold) occurs. If the battery power level is above the energy storage device threshold (YES), the method 1800A proceeds to step 1810. Otherwise (NO), the method 1800A proceeds to step 1809.

At step 1809, the Optimization Application Program 408 determines whether the current time is the last scheduled discharge period. The last scheduled discharge period allows the battery 106 to be discharged until it is exhausted to an energy storage device minimum power level and it is normally a period at the end of the day (e.g., the last 2 hours of the peak period). The minimum power level is determined by the Optimization Application Program 408 to ensure that the battery 106 is not exhausted to a point where the battery 106 can no longer be recharged. If the current time is the last scheduled discharge period (YES), the method 1800A proceeds to step 1810. Otherwise (NO), the method 1800A proceeds to step 1812.

At step 1810, the battery 106 is discharged and the method 1800A returns to step 1806.

At step 1812, the Optimization Application Program 408 determines whether the current time is a scheduled time for charging. The scheduled charging time may be determined by a user or by the Optimization Application Program 408 as described hereinbefore. If it is the scheduled charging time (YES), the method 1800A proceeds to step 1814 which charges the battery and returns to step 1812. Otherwise (NO), the method 1800A returns to step 1806.

The interrupt method 1800B is run by the Optimization Application Program 408 and is triggered when the electricity spot price exceeds a threshold. The threshold may be determined by a user. The interrupt method 1800B commences at step 1802 to discharge the battery 106. The method 1800B then proceeds to step 1803.

At step 1803, the Optimization Application Program 408 determines whether the battery 106 has reached its minimum power level. As mentioned hereinbefore, the minimum power level is set so that the battery 106 is not rendered inoperative due to an over-discharge. Although in some circumstances, it may be beneficial to set the target level so as to completely exhaust the battery 106. For example, if the nominal value of the battery is $20 and the complete discharge of the battery 106 prevents the user from paying an electricity spot price spike of $30, then the Optimization Application Program 408 sets the target level to 0 and allows the battery 106 to be exhausted. If the battery 106 is at or below the target level (YES), the method 1800B concludes. Otherwise (NO), the method 1800B proceeds to step 1804.

Step 1804 determines if the electricity spot price still exceeds the threshold. If the electricity spot price still exceeds the threshold (YES), the method 1800B returns to step 1802 to continue discharge of the battery 106. Otherwise (NO), the method 1800B concludes and the method 1800 returns to the discharge/charge scheduling method 1800A. The check at step 1804 may be performed at an interval of 5 minutes, 10 minutes, or any other intervals deemed to be acceptable by the user.

In one example of the operation of the alternative method, a 2 kVAh battery is used, the battery minimum power level is set by a user to be 1 kVAh, and the threshold for the electricity spot price is set by the user to be $5,000/MWh. Scheduled discharge periods are at 10 am to 11 am, 3 pm to 5 pm, and 8 pm to 10 pm.

The battery 106 is discharged at the three scheduled discharge periods. However, if at any time the battery 106 falls below the battery minimum power level of 1 kVAh, the battery 106 is not discharged at the next scheduled discharge period. For example, the battery 106 is discharged from 10 am to 11 am at a first scheduled discharge period. At 12 pm, the electricity spot price exceeds the threshold (i.e., $5,000/MWh) and the battery is discharged. The electricity spot price falls below the threshold at 2 pm and the battery 106 stops discharging and the battery 106 is now at 0.9 kVAh. Otherwise, the battery 106 continues discharging until it is exhausted.

At 3 pm, which is the next scheduled discharge period, the battery 106 is not discharged as the battery 106 is below the minimum power level. However, at 8 pm, which is the last scheduled discharge period of the day, the battery 106 is discharged until it is exhausted to take full advantage of the battery's capacity.

In operation, the PA 100 provides for the periodic storage of electrical energy at relatively low cost, and for consumption of that energy when mains supply costs are relatively high. Notably the preferred implementation takes account of costs associated with storing and supplying stored energy (e.g. battery replacement costs). The overall effect of this is a reduction in energy supply related costs to energy retailers and/or energy consumers, network operators and/or market operators.

For the energy retailer, the PA 100 provides a mechanism by which the impact of high spot prices can be reduced, whilst increasing consumption when costs are lower, thereby improving profit margins for the supplier.

There are three implementations of utilising the PA 100. The first implementation is when an energy consumer buys the PA 100. In this case, the optimal schedules of the PA 100 are based on minimising the electricity cost to the energy consumer. Typically, battery 106 is discharged when prices to the consumers are relatively high and is charged when prices to the consumers are relatively low.

The second implementation is when an energy retailer provides the PA 100 to the energy consumer. As the provider of the PA 100, the energy retailer is only concerned with minimising a retail supply cost of providing electrical energy to the load. Thus, the energy retailer prefers energy to be consumed from the mains supply only during periods of low electricity market and network pricing. Typically, PA 100 fulfils this goal by discharging the battery 106 when a combination of network and wholesale electricity price is high and by charging the battery 106 when the same combination of prices is low.

The third implementation is when a third party service provider leases the PA 100 to the energy consumers or retailers. The third party service provider typically has agreements with energy retailers and network operators for effectively reducing electricity consumption during peak periods. The third party service provider typically has agreements with energy consumers for providing reliable energy supply, which may be through determining a reliability price for various periods of the day. In this case, the optimal schedules of the PA 100 are based upon maximising profit to the third party service provider.

The arrangements described above provide for an optimal usage of a battery so that a user may gain the full value of the battery. The battery provides value by discharging to provide power at periods of high electricity prices and charging at periods of low electricity prices. Therefore, a reduction of running costs of an electrical load is the difference between the electricity prices during the discharging and charging periods minus a depreciation value of the battery.

The depreciation value is the depreciation of the nominal value of the battery. For example, a new battery may have a nominal value of $200 and a typical depreciation value of $1/day through its normal usage pattern. Therefore, after 100 days, the nominal value of the battery is $100.

In some circumstances, the arrangements described above can allow a battery to be completely exhausted and effectively destroy the battery if the value of exhausting the battery outweighs the value of keeping the battery alive. For example, if a long-used battery has a nominal value of $5 and the electricity spot price spike costs $15, then the present arrangements described can allow the battery to be exhausted, effectively killing the battery, to take advantage of the cost saving.

### INDUSTRIAL APPLICABILITY

The arrangements described are applicable to the electricity industries and particularly for the electricity retailers.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A power apparatus comprising:
an input connectable to a mains electrical supply;
an energy storage device;
a supply converter selectively connectable to an electrical supply to convert electrical power from the electrical supply to energy for storage in the energy storage device;
a load converter arranged to convert energy from the energy storage device to electrical power for supply to an electrical load;
an output, selectively connectable to either of the input or the load converter, by which the electrical load is coupled to the apparatus to receive electrical power; and
a control device, coupled to a communications network, configured to:
receive, from the communications network, time-dependent electrical pricing data associated with the mains electrical supply;
determine a schedule, using at least the received time-dependent electrical pricing data, for each of (i) charging the energy storage device, (ii) supplying electrical power from the input to the output, and (iii) discharging the energy storage device to the output;
selectively connect the supply converter to the input according to the schedule; and
selectively connect the output to either of the input or the load converter according to the schedule to provide electrical power to the electrical load.

2. A system comprising at least one power apparatus, a communications network, and a server computer device,
said power apparatus comprising:
an input connectable to a mains electrical supply;
an energy storage device;
a supply converter selectively connectable to an electrical supply to convert electrical power from the electrical supply to energy for storage in the energy storage device;
a load converter arranged to convert energy from the energy storage device to electrical power for supply to an electrical load;
an output, selectively connectable to either of the input or the load converter, by which the electrical load is coupled to the apparatus to receive electrical power; and
a control device, coupled to the communications network, configured to receive a schedule from the server computer device by which the control device selectively connects the supply converter to the input and selectively connects the output to either of the input or the load converter according to the received schedule; and
the server computer device is coupled to the communications network and is configured to:
receive, from the communications network, time-dependent electrical pricing data associated with the mains electrical supply;
determine the schedule for the power apparatus for each of (i) charging the energy storage device, (ii) supplying power from the input to the output, and (iii) discharging the energy storage device to the output, and
send the determined schedule to the control device.

3. The invention according to claim 1 or 2, wherein the electrical supply is the mains electrical supply associated with the received time-dependent electrical pricing data.

4. The invention according to any one of the preceding claims, wherein the electrical supply is an alternate supply to that of the mains electrical supply, said alternate supply being selected from the group consisting of a local solar supply, a local wind supply, a local hydroelectricity supply, and a local generator.

5. The invention according to any one of the preceding claims, wherein the device determining the schedule is further configured to:
receive a minimum power level for the energy storage device; and
prevent discharging of the energy storage device below the minimum power level.

6. The invention according to any one of the preceding claims, wherein the device determining the schedule is further configured to:
determine a load forecast based on historical electrical consumption data of the electrical load or a standard profile of the type of electrical load; and
determine the schedule for (iii) based on the determined load forecast.

7. The invention according to any one of the preceding claims, wherein the device determining the schedule is further configured to:
determine a forecast of the time-dependent electrical pricing data; and
determine the schedule based on the determined forecast of the time-dependent electrical pricing data.

8. The invention according to any one of the preceding claims, wherein the device determining the schedule is further configured to:
receive an energy storage device threshold;
receive a time-dependent electrical pricing data threshold;
prevent discharging of the energy storage device according to the schedule when the energy storage device is at or below the energy storage device threshold; and
otherwise, discharge the energy storage device when the received time-dependent electrical pricing data is at or above the time-dependent electrical pricing data threshold.

9. The invention according to claim 8, wherein the device determining the schedule is further configured to:
discharge the energy storage device below the energy storage device threshold when the schedule for (iii) is the last schedule for (iii) for a day.

10. The invention according to any one of the preceding claims, wherein the control apparatus is further configured to:
receive, from the communications network, weather data; and
determine the schedule using the received weather data.

11. The invention according to any one of the preceding claims, wherein the control apparatus further comprises:
a first controllable switch to selectively connect the supply converter to the input; and
at least a second controllable switch to selectively connect the output to either the input or the load converter.

12. The invention according to any one of the preceding claims, wherein the schedule comprises a discharge schedule of times when the load converter is connected to the output, and a charge schedule of times when the supply converter is connected to the input.

13. The invention according to claim 12, wherein the determination of the charge schedule includes consideration of a charge cost of the energy storage device.

14. The invention according to any one of claims 12-13, wherein the determination of the charge schedule includes consideration of a recharge profile of the energy storage device.

15. The invention according to any one of claims 12-14, wherein the discharge schedule and/or the charge schedule are determined to minimise discharge cost of the energy storage device.

16. The invention according to any one of claims 12-15, wherein the discharge schedule is determined based upon minimising an electricity cost to a consumer of operating the electrical load.

17. The invention according to any of claims 12-16, wherein the discharge schedule is determined based upon minimising a retail supply cost of providing electrical energy to the mains supply.

18. The invention according to any one of claims 12-17, wherein the discharge schedule and/or the charge schedule are determined based upon maximising profit to a third party service provider.

19. The invention according to any one of claims 12-18, wherein the discharge schedule and/or the charge schedule are determined to optimise an economic lifetime of the energy storage device.

20. The invention according to any one of the preceding claims wherein the energy storage device comprises a chemical battery; the supply converter comprises a rectifier and a battery charger; and the load converter comprises an inverter.

21. The invention according to claim 20, wherein the battery is selected from the group consisting of a lead-acid battery and a lithium ion battery.

22. The invention according to any one of the preceding claims, wherein the power apparatus further comprising:
sensors for monitoring parameters of the energy storage device, wherein the sensors are coupled to the control apparatus and the control apparatus determines the schedule using the monitored parameters.

23. The invention according to claim 22, wherein the sensors comprise a temperature sensor for monitoring temperature of the energy storage device, and wherein the determination of the schedule includes consideration of the monitored temperature.

24. The invention according to claim 22 or 23, wherein the sensors further comprise a voltage sensor for monitoring voltage of the energy storage device, and wherein the determination of the schedule includes consideration of the monitored voltage.

25. The invention according to any one of the preceding claims, wherein the power apparatus is transportable.

26. The invention according to any one of the preceding claims, wherein the power apparatus output comprises a power socket of a standard mains electrical power supply socket.

27. An application program, executable by a computerized processor for determining a schedule for an operation of a power apparatus, the power apparatus being configured to provide electrical power to an electrical load, the power apparatus comprising:
an input connectable to a mains electrical supply;
an energy storage device;
a supply converter selectively connectable to an electrical supply to convert electrical power from the electrical supply to energy for storage in the energy storage device;
a load converter arranged to convert energy from the energy storage device to electrical power for supply to an electrical load;
an output, selectively connectable to either of the input or the load converter, by which the electrical load is coupled to the apparatus to receive electrical power; and
a control apparatus configured for:
selectively connecting the supply converter to the input according to the schedule, and
selectively connecting the output to either of the input or the load converter according to the schedule to provide electrical power to the electrical load; and
the application program comprising:
code for receiving, from a communications network, time-dependent electrical pricing data associated with the mains electrical supply;
code for determining a load forecast based on historical electrical consumption data of the electrical load or a standard profile of the type of electrical load;
code for determining a schedule for discharging the energy storage device to the electrical load based on the determined load forecast, discharge cost of the energy storage device, and the received time-dependent electrical pricing data; and
code for determining a schedule for charging the energy storage device based on the discharge schedule, a recharge profile of the energy storage device and the received time-dependent electrical pricing data.

28. The application program according to claim 27, wherein the code for determining a load forecast further considers a factor selected from the group of factors consisting of:
weather data;
type of day;
type of month;
type of week;
type of season
type of interval; and
any combination of the above factors.

30. The application program according to claim 27, wherein the application program is stored in a memory of the control apparatus which includes the computerized processor.

31. The application program according to claim 27, wherein the application program is stored and executable in a server computer and further comprises code for transmitting the operating schedule from the server computer to the power apparatus via a communications network.
